(19) United States
(12) Patent Application Publication
(10) Pub. No.: US 2025/0059816 A1
(43) Pub. Date: Feb. 20, 2025

(54) GATE SYSTEM FOR SHAPE SELECTIVE PASSAGE OF AN OBJECT

(71) Applicant: Mark POHL, Berlin (DE)

(72) Inventor: Mark POHL, Berlin (DE)

(21) Appl. No.: 18/721,705

(22) PCT Filed: Dec. 21, 2022
(86) PCT No.: PCT/EP2022/087268

§ 371 Date: Jun. 19, 2024

(30) Foreign Application Priority Data
Dec. 22, 2021 (EP) 21000370.3

(51) Int. Cl. E05F 15/73

(52) U.S. Cl. CPC E05F 15/73; E05Y 2900/40

(57) ABSTRACT

The present invention is directed to a gate system capable of recognizing the shape of an object, for example a car, and generating a passage opening which is adapted to the shape of the object.

### CROSS-REFERENCE TO RELATED APPLICATIONS

This application is the United States National Phase under 35 U.S.C. § 371 of PCT International Patent Application No. PCT/EP2022/087268, filed on Dec. 21, 2022, which claims the benefit of European Patent Application No. 21000370.3, filed on Dec. 22, 2021, the disclosures of which are hereby incorporated by reference herein in their entireties.

### TECHNICAL FIELD

The present invention is directed to a gate system capable of recognizing the shape of an object, for example a car, and generating a passage opening which is adapted to the shape of the object.

### BACKGROUND

For entering or exiting a secured area such as a building or an installment usually a barrier in form of a single gate-bar is provided which hinders merely simple crossing. However, such bars can be easily passed by many objects which are not too big to pass. For example, for human beings such bars can be easily trespassed by climbing over said barrier. To further prevent access to locked buildings or installments door systems, such as garage doors, are of help as trespassing is only easily possible when the doors are open.

However, door systems are configured to open a large space which is much bigger than the object to pass through. Also, usually such systems remain open for quite a while to give the driver of a vehicle sufficient time to drive through the opening. In such a situation, when the vehicle has passed through the open door in a building the access area is vulnerable for a criminal to also pass through the gate or door in the shadow of the back of the car. After trespassing into a secluded area, for example in a private environment, an intruder can easily rob the car driver who is supposed to be secured by the gate system.

In Chinese Publication No. 209543444U a gate system is shown which is supposed to adapt to the breadth of a car to minimize a gap between a vehicle and the wall. However, the system relies also on a bar gate and can easily trespassed as outlined above. In U.S. Pat. No. 9,689,189 B1 a passage area is disclosed which can be closed by telescope bars. Such system does not show any capability of adapting those telescope bars to the shape of a passing object. It merely opens fully or closes the passage area. In Chinese Publication No. 1 08 978 380 a gate system for preventing red light running in urban traffic is disclosed. Also, such system is not configured to adapt to a shape of a passing object.

It is therefore the object of the present invention to present a gate system minimizing the likelihood for intruders to enter an area which is secured by the gate system.

### SUMMARY

The present invention accordingly is directed to a gate system for entering and exiting a building or installment through a passage area comprising a plurality of moveable means at the passage area in a first position which does not allow passage, characterized in that the means are capable adopting a second position to open the gate by adapting the second position to a distance corresponding to the shape of the passing object to a predetermined, preferably minimum, value without touching the object.

With such a system only a minimum passage opening is generated which allows passage for the object intended to pass, but almost no additional space is opened for intruders. Also, the system is configured to close quickly after passage of the object to minimize the likelihood for trespassing. The system is configured and adapted to create an opening which resembles, merely roughly, the shape of the passing object. Thereby, the system is configured to shape the opening in breadth and height corresponding to the passing object. Sensors are configured to detect the shape of the car and corresponding to the shape the movable means adopt the second position without touching the passing object having distance to the passing object, wherein the difference between the first position and the second position is the related to the shape of the passing object in addition to a predetermined, preferably minimum, distance between the movable objects and the passing object, in particular in breadth and height. The opening is thereby smaller than the overall passage area provided by the bottom, ceiling, left and right side. Thereby, the system as described herein is different to existing systems which are either closed or open the passage area completely. Hence, the system as described herein is capable of providing adaptability to a passing object is terms of height and breadth. The first position of the movable means as described herein is a position farthest into the passing area and supposed to prevent passing of an object.

Moveable means at the passage area can embodied in different ways such as fans, bars, plates, folding grille, air cushions or flexible, but solid curtains. Such means as part of the gate system according to the present invention can be configured in particular for passage of motor vehicles, in particular cars and motorcycles. However, the gate system can also be used for human beings or animals. In certain embodiments the movable means formed by bars or plates, in particular divided plates having sub-plates. Those plates can be configured to be flexible in adjusting their length towards the passing object by being divided into sub-plates along the breadth of the plate. Plates in the meaning of the present invention may also mean that the plates, also in the form with sub-plates, are flexible in longitudinal direction by having smaller plates being connected by connecting means such as hinges bolts or the like. Plate in the meaning of the present invention having flexibility in longitudinal direction. Plates may further have the plain meaning of a solid board not being divided or having flexibility in longitudinal direction. In certain embodiments it may be chosen that two different kinds of movable means are used for the gate system. It may be that bars or plates are used for movable means from the side and a different kind of means from the ceiling or the bottom. One embodiment may comprise rolling shutter from the ceiling as a form of flexible plates and bars or plates with sub-plates from the side.

The gate system as defined herein relies on the use of sensors capable of recognizing the shape of the object to pass and transmission of data to the moveable means to adapt their position to a predetermined, preferably minimum, distance to the object to allow passage. Such sensors can be directly located on the moveable means, but could also be located in the passage area alone or in combination with sensors on the moveable means.

The moveable means can be located at every of the four possible sides, meaning bottom, ceiling, left side and right side. In case the passage area is round in some way or does not have shape with the usual four sides (e.g., an arch), then the moveable means can be integrated into the construction of the passage at least at those sections which face the two sides of the vehicle and the ceiling area. In one embodiment moveable means are installed at three side, preferable ceiling, left and right side. In another embodiment moveable means are only located at both sides, left and right. In one other embodiment the moveable means are only located at the ceiling. If the means are located either at the ceiling or at the sides it is possible to provide a system capable of adapting the height of the opening to the height of the object to pass. This also holds true for a system which provides movable means from the ceiling and from the bottom which is another conceivable embodiment. A system which provides only means from the bottom cannot provide height control as it is necessary for generating the opening for passage to remove or retreat the bottom means almost completely leaving the ceiling area complete free. Thereby, the present gate system provides the advantage of height adaptation and minimizing the space above the object to pass.

As mentioned above, the moveable means are supposed to keep a predetermined, preferably minimum, distance from the passing object. In particular, the means are arranged in the second position in such a way that a human being or bigger object cannot trespass between the movable means and the object to pass. In one embodiment the distance between the object to pass and the tip of movable means is only a few centimeters and in particular less than 20 cm, preferably less than 10 cm and most preferably less than 5 cm. The system further is configured and adapted to set the movable means in distance to the passing object which correspond to the shape of the object. Thereby, depending on the movable means the ends of the movable means do not form a straight line in parallel to the borders of the passage area, but form a line which resembles the shape of the cross section of the passing object. The skilled person will understand that movable means cannot resemble the cross section of the passing object in the smallest detail, but in rough means given by the predetermined distance from the movable means.

Also, the gate system is supposed to prevent passage for an object of the extent of a human being or bigger when the movable means are in the first position. Depending on the nature of the means the space between the means should not allow sticking a head through an opening. In case bars are used as movable means the distance between the bars is less than 20 cm, preferably less than 10 cm. Preferably, the density of bars is 8 bars per meter, more preferably 10 bars per meter and most preferably more than 12 bars per meter.

The gate system may further comprise a sending and receiving unit for remotely activating the gate system. Such unit can be configured as a remote control. A different way to implement an automatic opening of the gate system can be achieved by a memory function capable of remembering previously passed object shapes and adapting the second position of the bars according to the shape of the previously passed object. Such a function could be supported by a license plate recognizing tool.

In one embodiment of the present invention the moveable means are bars which are installed to or integrated into at least two sides of the passage area. It is also conceivable to only have those bars solely located at the ceiling.

As mentioned above the gate system as defined herein relies on the use of sensors capable of recognizing the shape of the object to pass and transmission of data to the moveable means to adapt their position to a minimum distance to the object to allow passage. In one embodiment each movable means, for example each bar or plate, has at least one distance sensor at the tip area closest to the object to pass for measuring the distance to a passing object. It may also be that the movable means such as a bar or a plate do not carry a distance sensor and the distance sensing is conducted at a different location. In case the distance sensor is located at the tip area of the movable means closest to the object to pass it may be configured for measuring the distance in the extended direction of the means. This holds true especially for embodiments where bars deflectable plates are used as movable means. It may also be that the distance sensor is located at the tip area directing towards the passing object deviating from the extended direction of the bar. It may further be that the distance sensor is located at the tip area directing towards the passing object and measuring is conducted in the extended direction of the bar and in a direction deviating from the extended direction of the bar.

In one embodiment the moveable means are configured as telescope bars. Telescope bars have the advantage that they can be used to cover long distances into the passage area, but only demand little or no room inside the side wall or ceiling for their installment. Using telescope bars as moveable means are therefore preferred as only minimal room has to be provided in the passage area and the construction around it.

The bars, and in particular telescope bars, located at the same side wall or the ceiling are arranged parallel to each other. In that the distance between the bars can be adapted in such a way that passage and in particular trespassing is made impossible when the bars are in the first position.

As mentioned above sensors can be located on the moveable means, but could also be located in the passage area alone or in combination with sensors on the moveable means. In one embodiment of the gate system as defined herein the system further comprises distance sensors before and behind the moveable means, e.g., the bars and preferably telescope bars or deflectable plates, in the direction of the passage of the object to pre-assess the dimensions of the object to pass to trigger the movement of the means to the second position. In one embodiment those distance sensors, preferably a plurality of sensors, are integrated into the side walls and the ceiling in one plane as an assembly to assess the shape of the object to pass from three sides. Thereby, it is possible to scan the shape of the object in breadth and height and facilitate adaptation of the opening to the shape of the object. It may further be that more than one assembly of sensors in more than one plane parallel to the plane of the moveable means are installed. In such a manner a three dimensional shape can be measured and the moveable means can be adapted to the passing object accordingly.

The system may work in such a way that when an object is approaching the passage area the system is activated. The object will enter a plane with distance measuring sensors. The dimensions of the object will be transferred to the gate system and the opening will be adapted to the shape of the object in that the moveable means adapt a second position according to the shape of the object. Optional sensors at the moveable means can assist to keep distance of the means to the object. Once the object has passed the passage area the movable means return to the first position and the passage area is closed again. During the passage the second position will be adapted to the shape of the object by the information provided either of the sensors on the moveable means or by the sensors before and optionally also behind the passage area.

The system as described herein may be constructed in such a way that the regimes of side (breadth) control and height control are distanced from each other in direction of passing, hence perpendicular to the plane of the passing area. In that it may be that the height control is passed first and then the side control is passed thereafter or the other way around. The distance between those two regimes shall not be large enough to allow trespassing. It is conceivable that both regimes form a complete closure of the passage area in the first position and then adopt the second position to allow passage of the passing object. Thereby, a high degree of security is provided as two complete and closed gates can be provided in the passage area. In an embodiment height control can be provided first by movable means being integrated in the ceiling. Such movable means can also be combined usual garage door system like a plain door or a rollable curtain as long as those systems are capable of adapting their position corresponding to the height of the passing object. Before or after the movable means for height control movable means for side control are provided. Those movable means can be provided from the left and the right side or from the bottom or both. Movable means from the bottom may also be equipped with turnable or pivoting sub-means which are capable of adapting side distance to the passing object. Such sub-means may also be integrated into movable means which are used at the upper side to also adapt to the height of the passing object.

The system as described above is configured to be stationary and integrated into a construction. However, it may also be that the system is configured to move from a starting position in front of the passing object to an end position behind the passed object. In such a system the passage area comprising the movable means passes around the object which does not move while the system passes around.

Additional features, aspects, objects, advantages, and possible applications of the present disclosure will become apparent from a study of the exemplary embodiments and examples described below, in combination with the Figures and the appended claims.

### BRIEF DESCRIPTION OF THE DRAWINGS

In the following, embodiments of the present invention as well as further features and advantages of the present invention shall be described with reference to the Figures, wherein

FIGS. 1A-E show schematically one embodiment of the present invention wherein bars, in particular telescope bars, are used as moveable means and vehicles as objects to pass;

FIGS. 2A-E show schematically another embodiment of the present invention wherein bars are used as moveable means and vehicles as objects to pass;

FIGS. 3A-M show schematically another embodiment of the present invention where plates in different embodiments are used as moveable means a vehicles as objects to pass;

FIGS. 4A-E show schematically another embodiment of the present invention wherein air cushions are used as moveable means and vehicles as objects to pass;

FIGS. 5A-B show schematically another embodiment of the present invention wherein bands of folding grille are used as moveable means and vehicles as objects to pass;

FIGS. 6A-E show schematically another embodiment of the present invention wherein fans are used as moveable means and vehicles as objects to pass;

FIGS. 7A-C/8A-C show schematically another embodiment of the present invention wherein bars are used as moveable means located in the ceiling and vehicles as objects to pass;

FIGS. 9A-B show schematically another embodiment of the present invention wherein bars are used as moveable means located in the ceiling and the ground, and vehicles as objects to pass;

FIGS. 10A-B show schematically from the top and from the front distance sensing at the distal tip of a telescope bar as an example for a moveable means;

FIG. 11 shows schematically distance sensing that can work from inside as well as to the outside of the passage area;

### DETAILED DESCRIPTION

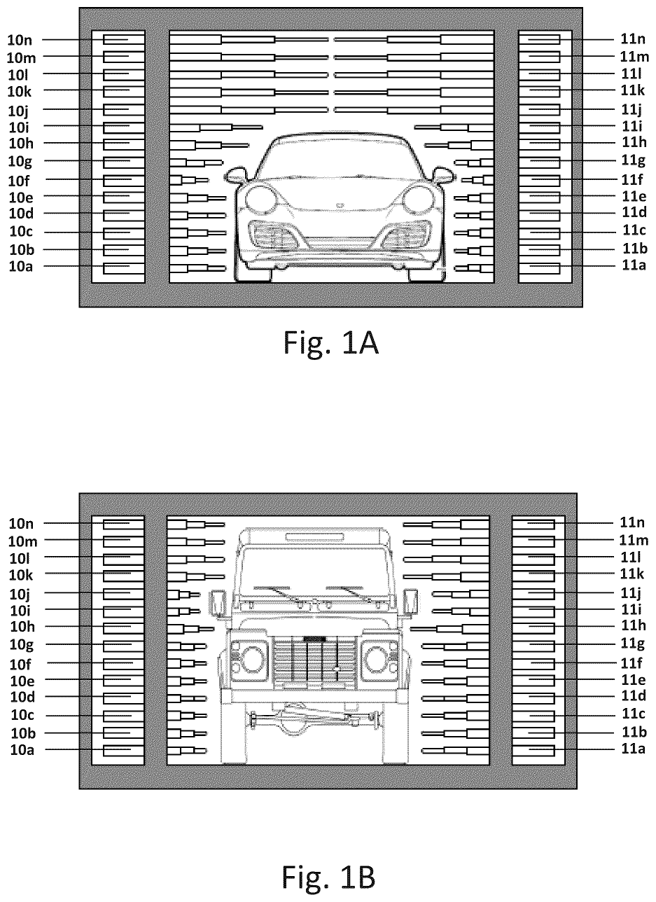

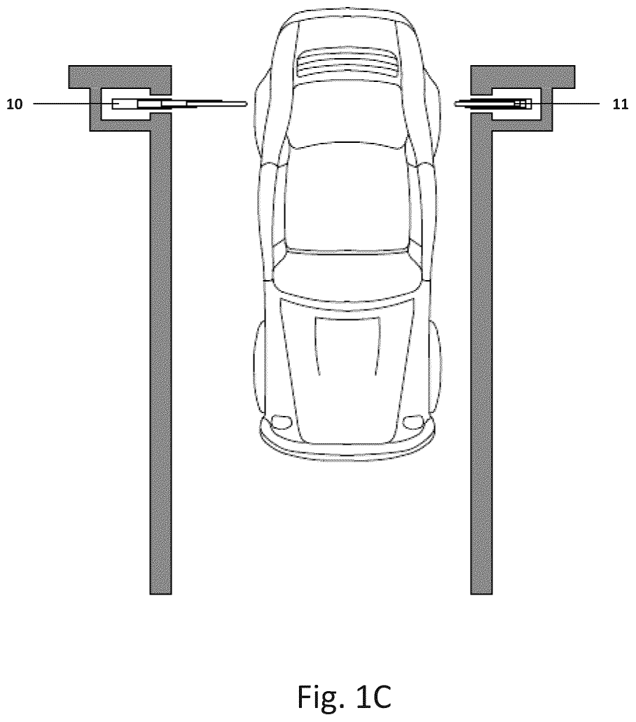

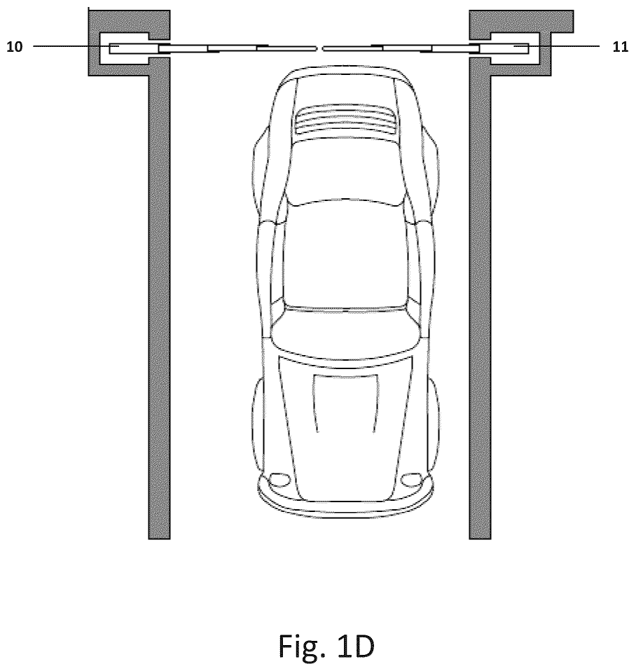

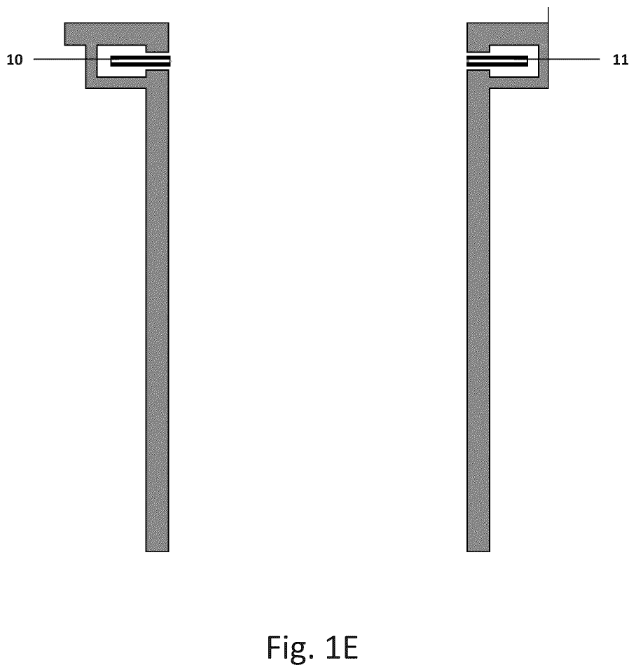

In FIGS. 1A to 1E one embodiment of the present invention is shown. The system comprises telescope bars from the left side (10a-n) and bars from right side (11a-n). In FIG. 1A where a rather flat car is passing the passage area the lower bars (10 and 11a to i) are only drawn as far to the side as necessary to allow passage of vehicle 1. The upper bars (10 and 11j-n) remain in the first position and thereby provide to possibility of an adaptable upper limit according to the height of the object. Accordingly, in case a rather high car is passing through the passage area, if necessary as shown here, all bars 10 and 11a to n are in the second position and allow a shape adapted passage. For instance, bars 10 and 11l, j are in a very retracted position to allow the side mirrors to have the same distance to the bars as the rest of the side of the car. In FIGS. 1C to E top view sights are presented. In FIG. 1C the system is shown while an object, here a car, is passing through the passage area without yielding to much space between the bars and the object for unauthorized passage. In FIG. 1D the system is shown after passage of the object. It can be seen that the system will close shortly after the object has passed through the passage area avoiding a longer time of an open passage area providing a hidden opportunity for unauthorized passage. For the sake of completeness, in FIG. 1E it is shown the system is also supposed to provide a mode where the passage area is completely open. Such a mode might be necessary to adopt in case of an emergency.

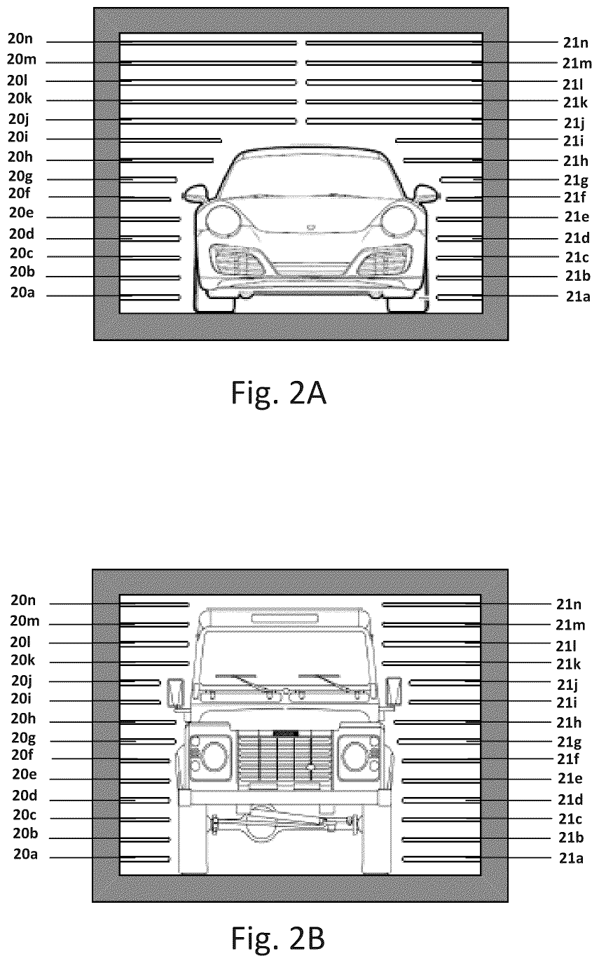

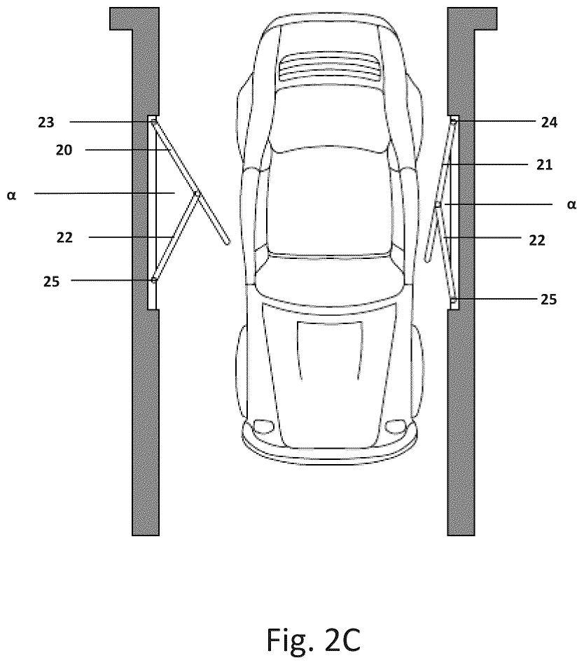

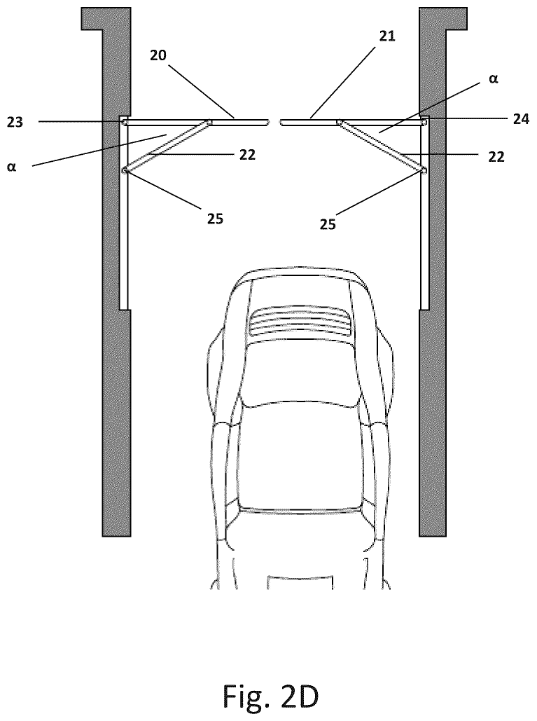

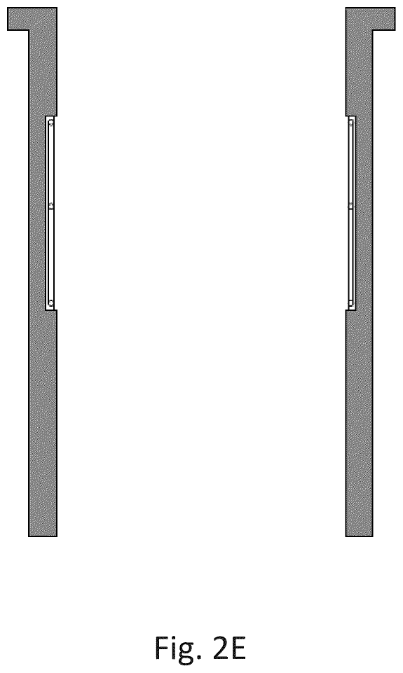

In FIGS. 2A to E another embodiment of the present invention is shown. Here the moveable means are bars 20 and 21a to n. The bars 20 and 21 are provided with a different functionality as the telescope bars 10 and 11, but show the same effect for shape selective passage. As can be seen from FIGS. 2A and 2B bars 20 and 21 can be used to provide an adaptive height for the passage as well as provide passage adapted to the shape of the passaging object, here again in the form of a rather flat and a high car. As illustrated in FIG. 2C bars 20 and 21 are attached to a connecting bar 22. Connecting bars 22 forms an angle α with either with bar 20 or 21. The more the bars 20 or 21 are moved away from the passing object the bigger angle α becomes. Further, connecting bar 22 is on the one end attached to bar 20 or 21 and on the other end attached to a track implemented into the sidewall of the passage area. The more side space shall be provided for the passing object the farer the attachment point for the bars 23 or 24 respectively, and the connecting point of connecting bar 25 are moved away from each other. After the passage of the object, bars 20 and 21 can be closed again by moving connecting point 25 again in direction of the steady connecting point 23 or 24 respectively until bars 20 and 21 are back in the first position. This is shown in FIG. 2D. Also, the embodiment of FIG. 2 can be adapted that the entire passage area is made open, for example in case of an emergency, as illustrated in FIG. 2E.

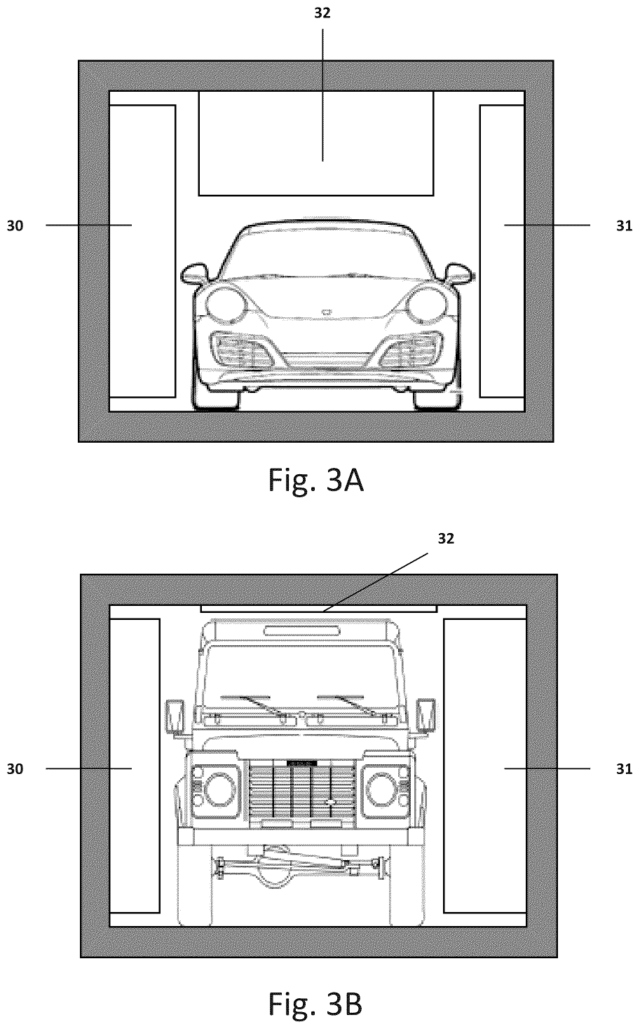

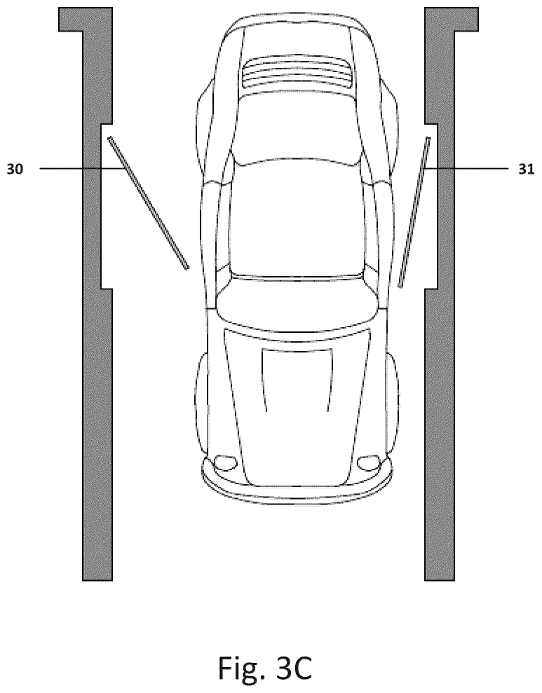

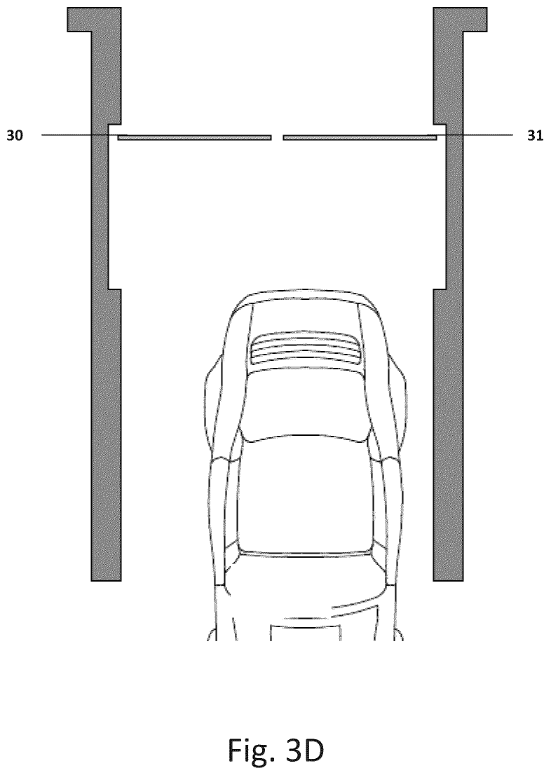

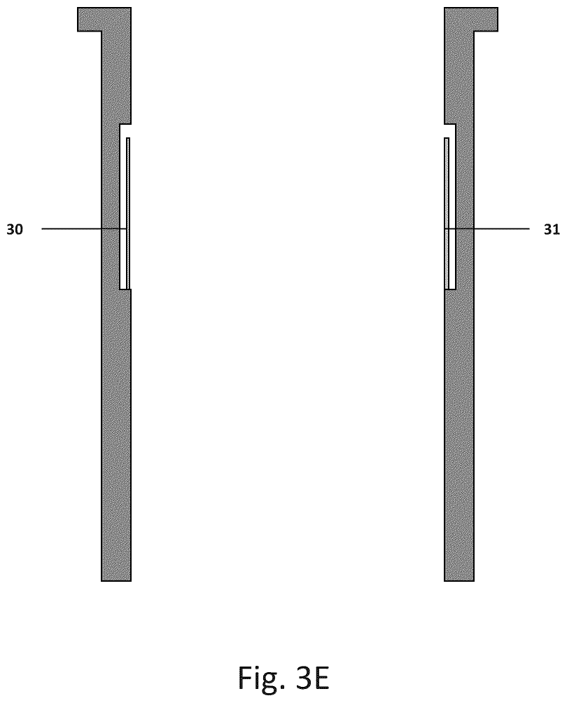

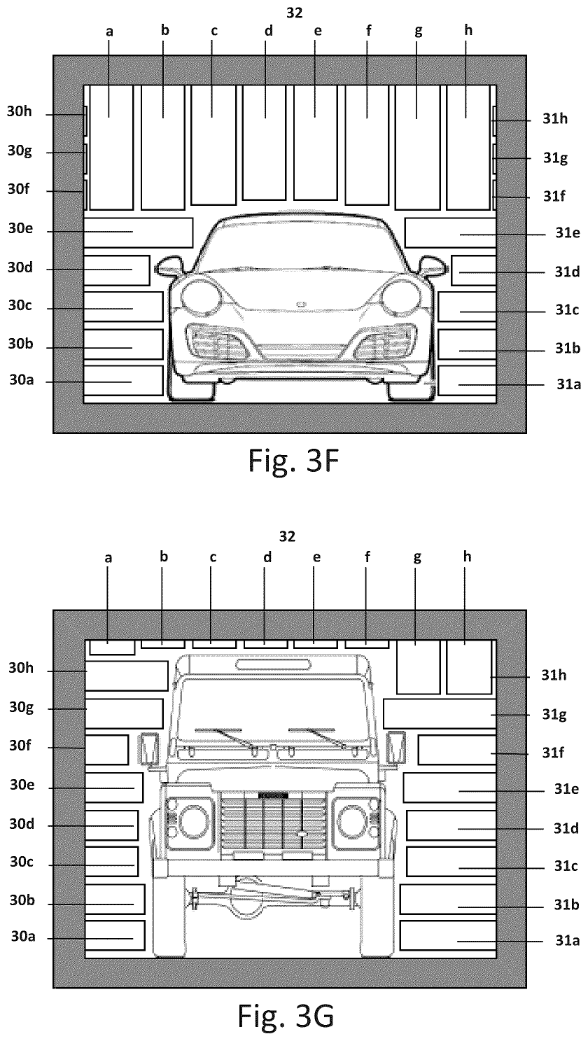

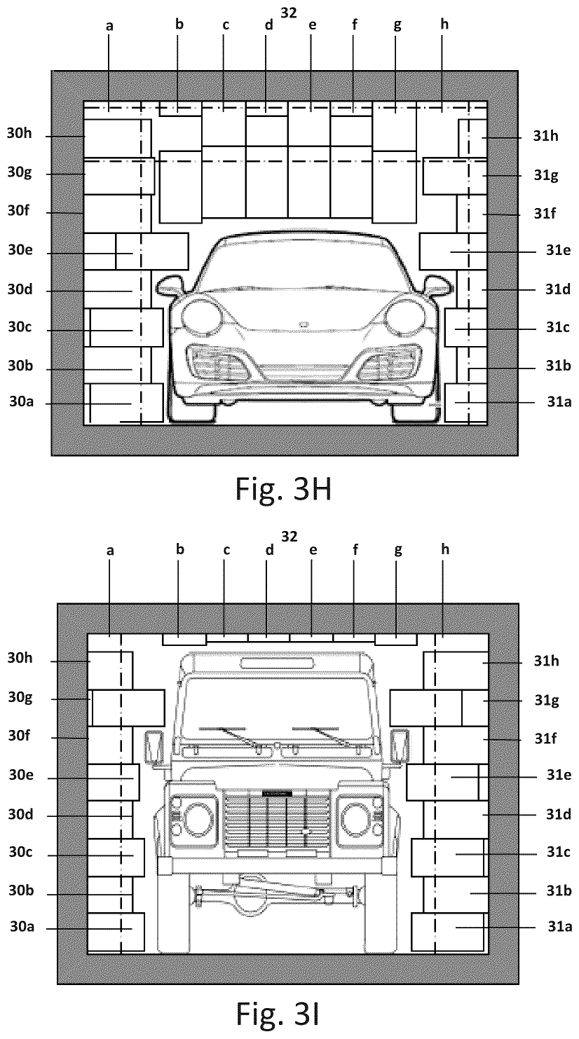

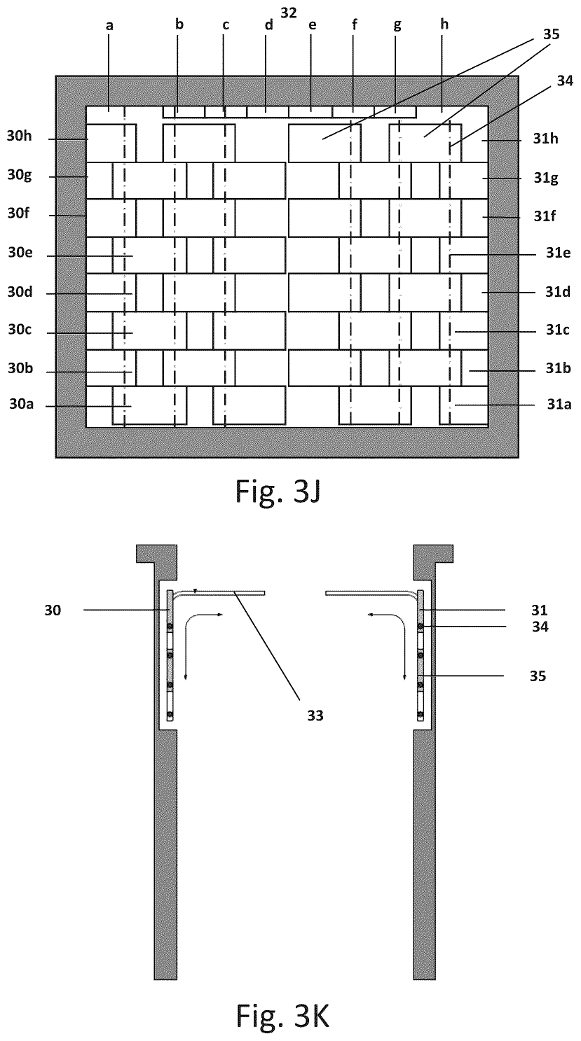

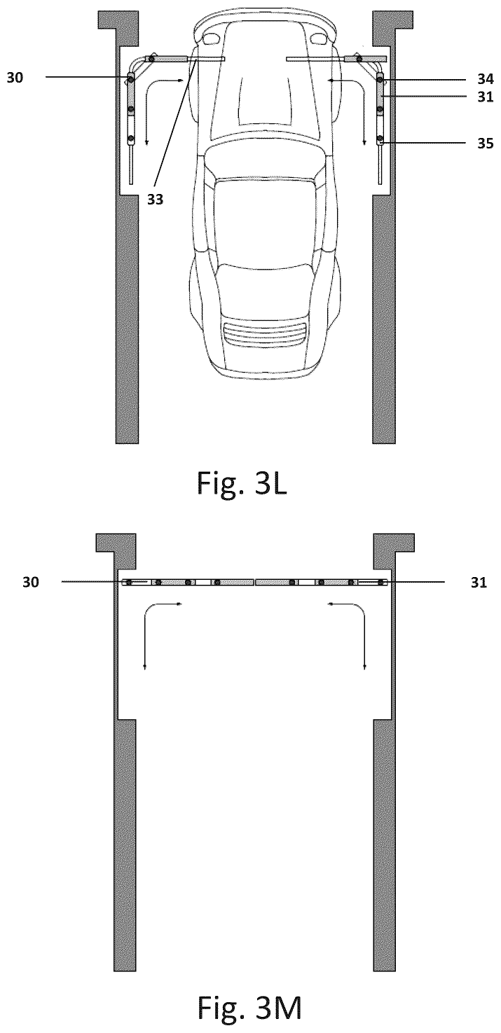

In FIGS. 3A to E another embodiment of the present invention is illustrated. In this embodiment the shape adapted passage is not provided by movable means in the form of bars, but in the form of plates 30, 31 and 32. Plates 30 and 31 are used to adapt the breadth of the passage area, whereas plate 32 is attached to the ceiling and is used to adapt the height of the passage area. As can be seen from FIGS. 3A and 3B plates 30 to 32 can be used to provide a shape adapted passage for an object. For instance, as shown in FIG. 3B when a high object is passing the passage area upper plate 32 is almost completely retracted. FIG. 3C provide a top view on the present embodiment. When an object is passing through the passage area side plates 30 and 31 are individually from each other retracted to provide a side (and height, not shown) adapted passage. After the object has passed through the area, all plate return to the first position and the passage area is again closed. Also, the embodiment comprising plates as movable means can be provided in manner that the passage area is completely open (FIG. 3E). Retraction of the plates 30, 31 and 32 can be achieved by different means. As indicated by FIG. 3C the plates can be pivoted from the passing area to the side and to the ceiling. Plates 30, 31 and 32 cab also be integrated into the construction and just retracted parallel to the passing plane away from the passage area. Also, especially from the ceiling plates 30, 31 and 32 can be provided in the form of rollable curtains or roller shutters which are spaced apart in the passing direction and move on side and ceiling and bottom tracks.

Plates 30, 31 and 32 can individually be divided into sub-plates 30a-h, 31a-h, 32a-h which can be individually retracted in order to adapt to the shape of the passing object (FIGS. 3F and G). The degree of dividing plates 30, 31 or 32 can be freely chosen. Plates 30, 31 or 32 can be divided only once into two sub-plates. However, the degree of dividing the plates can be much higher. Exemplary, in FIG. 3F it is chosen that plates 30, 31 and 32 are divided into eight sub-plates. In FIG. 3F a lower car is passing through the passage area. Ceiling movable means 32a-hadopt a second position with a low degree of retraction. The movable means at the side 30 and 31a-e adopt their position to the shape of the passing object. Upper movable side means 30 and 31f-h may be completely retracted to give space from the ceiling means 32. In related embodiment means 32 on the one hand and means 30 and 31 are distanced apart in the passing direction and means 32 as well as upper side means 30 and 31 overlap in passing direction. As shown in FIG. 3G it may also be an option that ceiling means 32 are mainly retracted in their second position and side means upper side means 30 and 31f-h adopt their second position to the shape of the passing object.

In FIGS. 3H and I a more detailed embodiment to FIGS. 3F and G is shown. Here movable means are plates which are divided over the length of each movable mean, hence in their longitudinal direction. Thereby plates 30, 31 and 32 and of course sub-plates 30a-h, 31a-h, 32a-h are chains or rows of smaller plates 35 (see FIGS. 3K-M). Hence, such smaller plates 35 may be directly behind one another. It may also be that a predetermined distance between two smaller plates 35 is provided. In FIG. 3K such distance is indicated by a white space between two grey pieces 35. In FIG. 3H and I the shape of the passing object is adapt by the movable means 30a-h, 31a-h and as described before. 32a-h. also here, it may be chosen to have a distance between the means 32 from the ceiling and those side means 30 and 31. In FIG. 3J the system is shown in closed state. It is indicated that the ceiling means remain retracted in the same plane as side means 30 and 31. It is also possible as indicated herein that the ceiling means 32 are in distance to side means 30 and 31 and are also completely closed thereby forming second closed gate before or behind the plane of means 30 and 31. In the closed position it may be that there is space between small plates 35. As indicated above it may also be that there is no space provided between small plates 35 and therefore the closed gate appears rather like garage door. If space is provided between small plates 35 the distance is preferably chosen that trespassing is not possible. In an embodiment the distance between small plates is smaller than 20 cm and preferably smaller than 10 cm.

Further as indicated in FIGS. 3K to M, plates 30, 31 and 32 can be configured in such a way that they are deflectable in longitudinal direction. Such deflectability can be introduced by deflection means 34 such as hinges, flexible joints or the like. The retraction of the movable means can thereby be achieved not only by pivoting the movable means from the plane of the passing area, but also pulling back around a deflection pulley or tracks 33 provided at the bottom or on the ceiling or both. The technical advantage of this embodiment of the present invention is a system which can be integrated into existing buildings or passage areas as the system does not need much additional space in the extension of the passage area, but can be integrated along the passing direction of the passing object without requiring addition space which would reach into a neighboring building or object. In FIG. 3K tracks 33 are shown to lead around the corner and movable means 30 and 31 follow such lead. Tracks 33 can be provided at the bottom, but also at the ceiling as indicated in FIG. 3L where such indicated ceiling tracks lie above the passing object. In FIG. 3K the system comprising plates 30 and 31 are shown in the closed state

Sub-plates 30a-g, 31a-g and 32a-g can be configured in such a way that the plates are merely placed close to one another with or without space between each sub-plate. Sub-plates 30a-g, 31a-g and 32a-g can also be configured that some or all sub-plates are stacked and connected to one another, e.g., in a form-fit or positive locking manner. Such form-fit connection can be achieved, e.g., by a male and female shape in cross section. In all embodiments with sub-plates each sub-plate remains moveable with respect to one another in order to guarantee individual retraction for adapting the second position corresponding to the shape of the passing object. In an embodiment where movable means are integrated into at least one side of the passage area the bottom of plate 30 and/or 31 or of sub-plate 30 a and/or 31 a may have means which support sliding over the ground such as a track or a rail or wheels or rolls integrated balls. In such embodiment the sliding support means do not only facilitate easy retraction of the lowest movable means, but also carry much of the weight of all movable means.

Deflection pulleys according to an embodiment as described herein may be in the form of rolls, wheels or round bar. Further as indicated already above tracks 33 can all be effective means to provide deflectability.

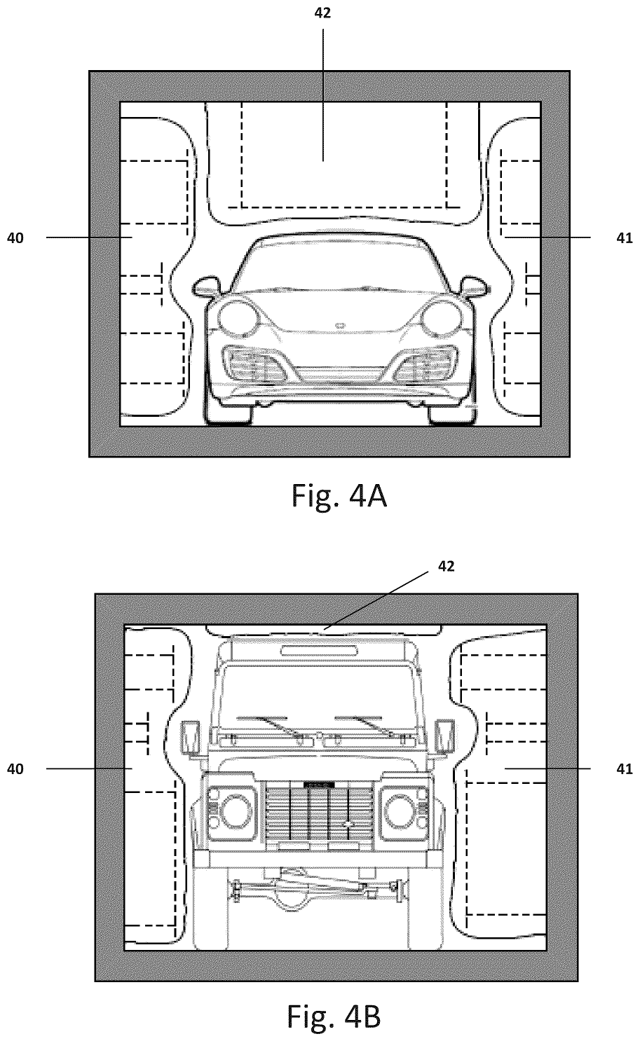

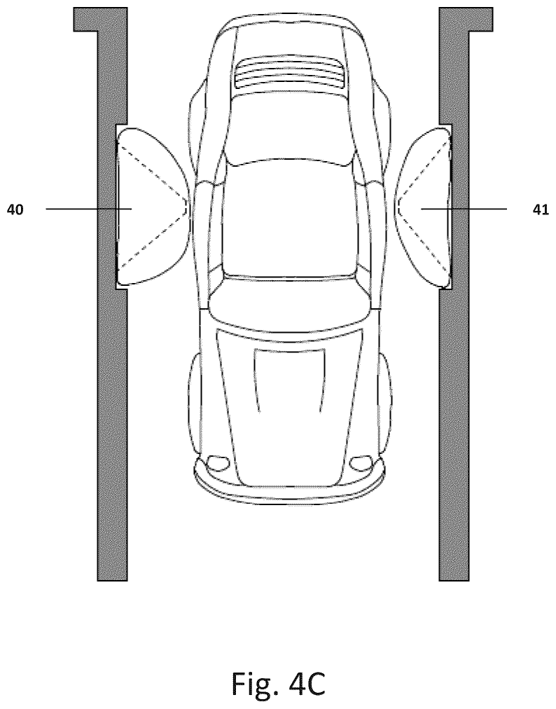

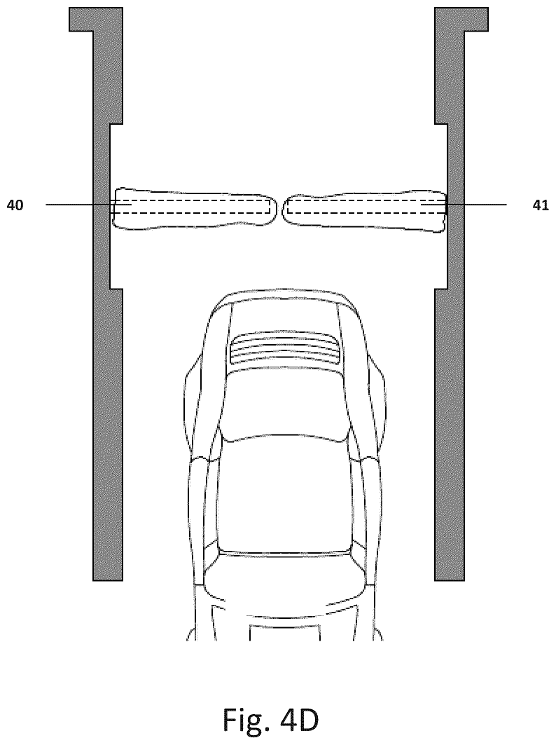

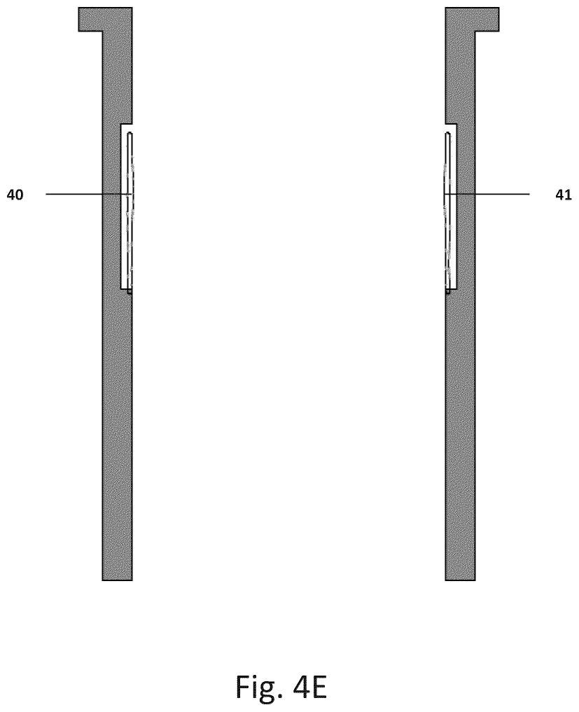

A further embodiment of the present invention is shown in FIGS. 4A-E. In this embodiment the movable means are configured and implemented as air cushions 40, 41 and 42. The air cushions 40, 41 and 42 comprise angle pieces a, b and c which stretch the cushion material 44 being spanned over the angle pieces. Additional ventilators implemented in the side wall s can be used to inflate air cushions 40, 41 and 42. By air cushion 42 also this embodiment can be provided with an adaptable height as be seen from comparison of FIGS. 4A and 4B. FIG. 4C provides a top view from an object passing through the passage area in a shaped adapted way and the system can be closed fast after the object has passed through the passage area as shown in FIG. 4D. Also, the embodiment with air cushions 40 to 42 can be provided in a manner that the passage area is complete free as illustrated in FIG. 4E.

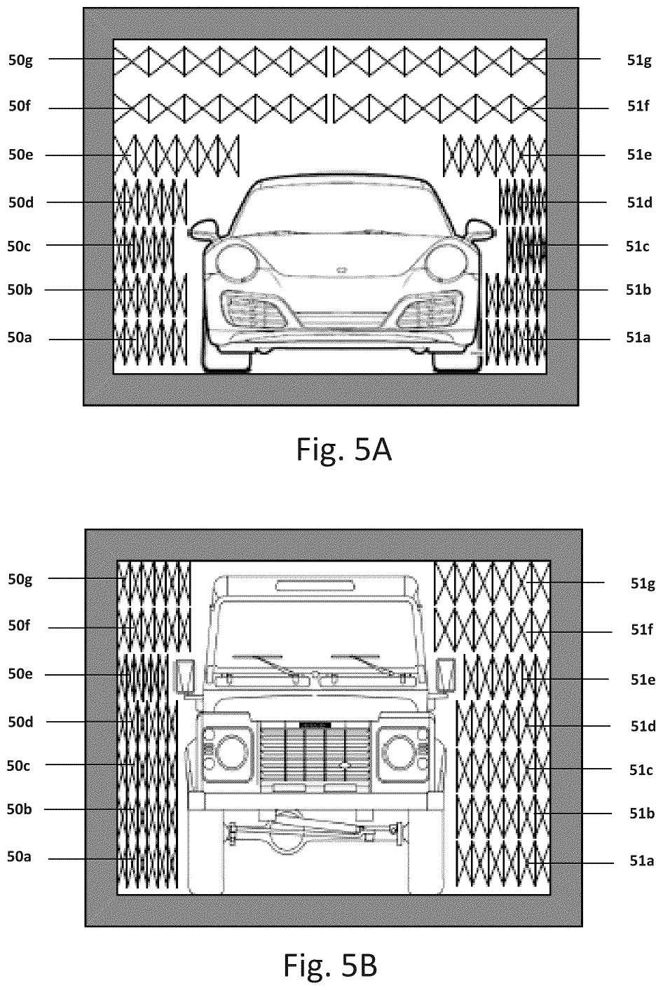

FIGS. 5A and B show a further embodiment for the gate system as described herein. Bands of folding grille (50 and 15a-g) is used as movable means for adapting the breadth and the height of the passage area. In that if a shallow object is passing bands of folding grille 50 and 51f-g remain closed while the other bands of folding grille 50 and 51a-e are adapted to the shape of the passing object. In case a high object is passing all bands of folding grille 50 and 51a-g take a position adapted to the shape of the passing object.

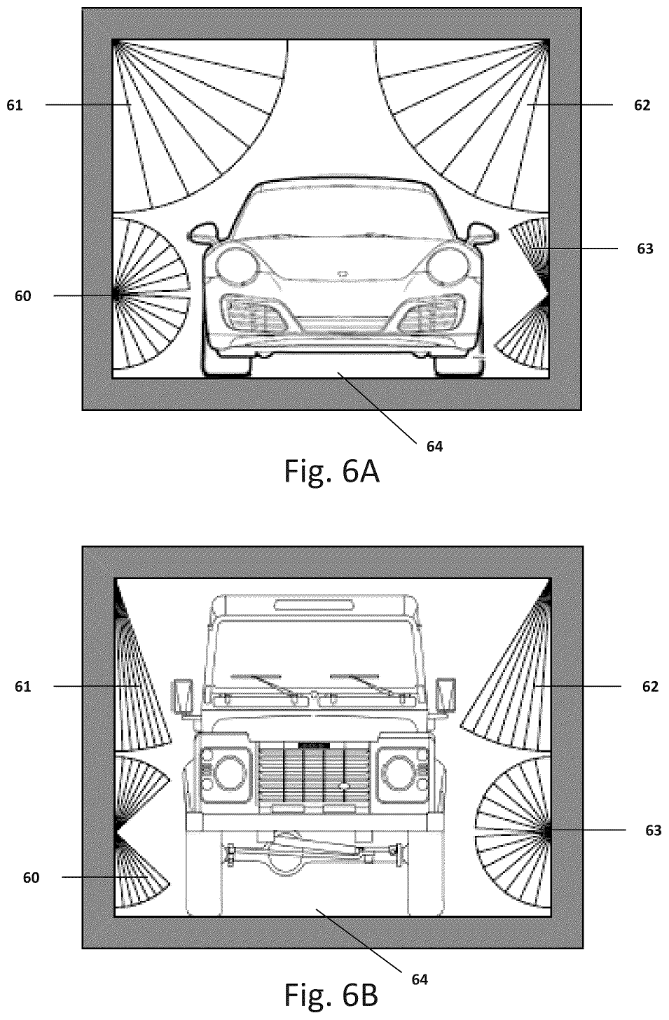

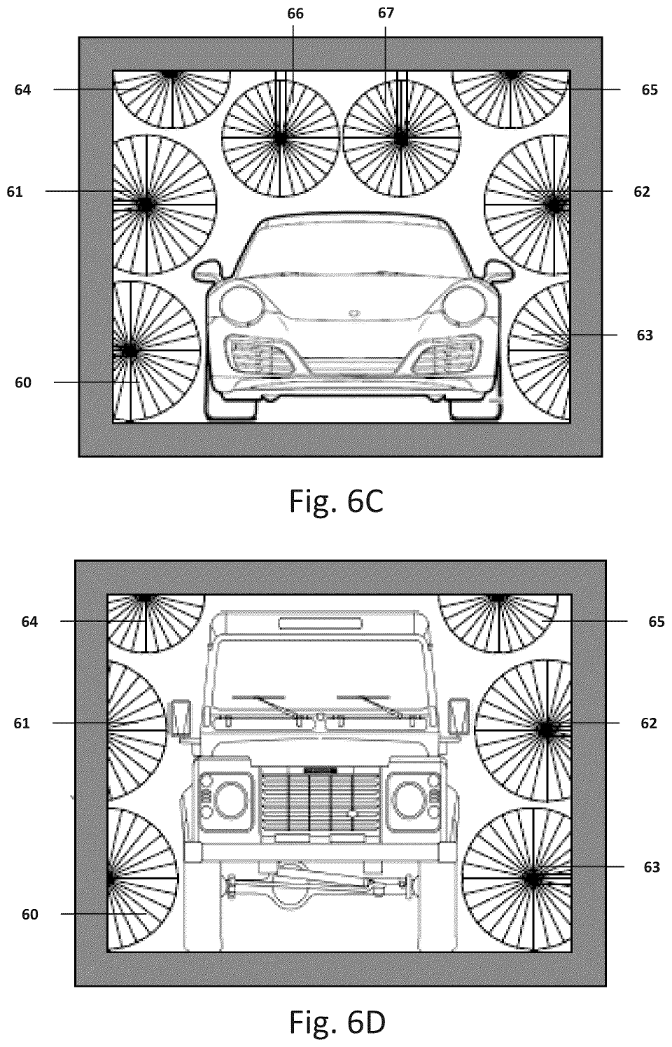

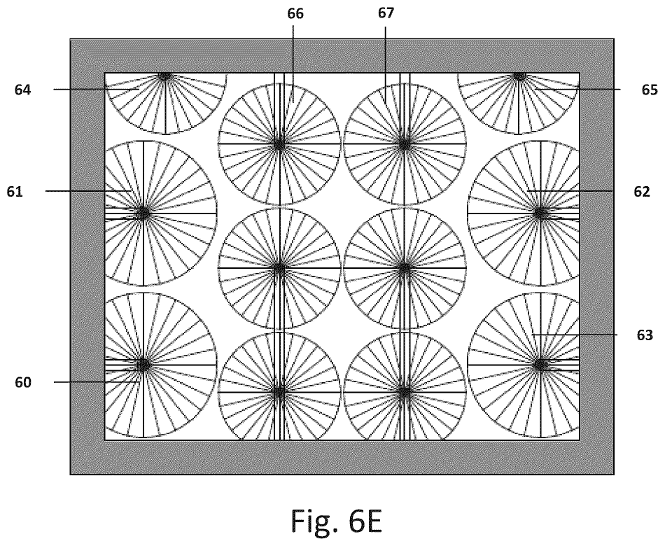

In an alternative approach the movable means can be implemented as fans 60, 61, 62 and 63 as illustrated in FIGS. 6A-D. As shown by comparison of FIGS. 6A and 6B the height and the breadth of the passage area can be adapted by the level of unfolding of the fans. Further, the embodiment is supposed to encompass additionally to fans 60, 61, 62 and 63 a fan 64 (not specifically illustrated) which is located at the bottom of the passage area to prevent free passage of small vehicles which fit into the area between the fans when completely unfolded. Together with a bottom fan 64 (not specifically illustrated) in the middle of the passage area an opening generated that is narrow enough that no intruder can trespass. In FIGS. 6C-E an alternative approach by means of fans is illustrated. Here the fans themselves are movable in the passage area. FIGS. 6C-E show an increased number of fans as movable means 64 to 67 at the side and at the ceiling an effective adaptable height can be provided also with fans. As shown in FIG. 6E the system can be adapted to close the entire passage area for trespassing.

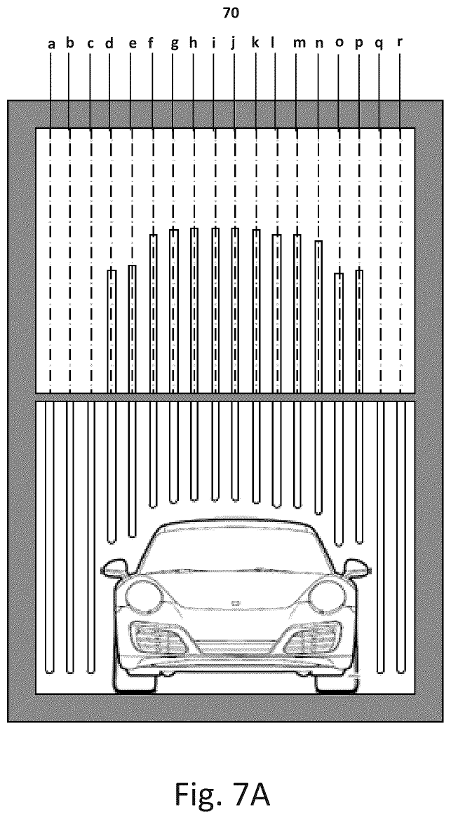

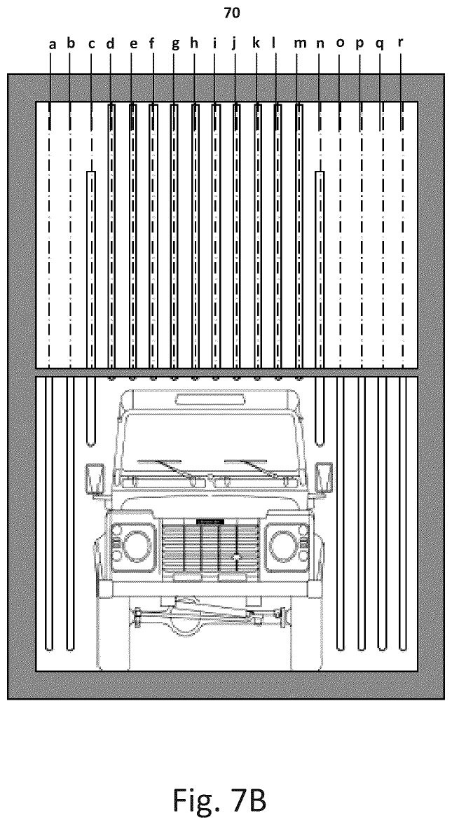

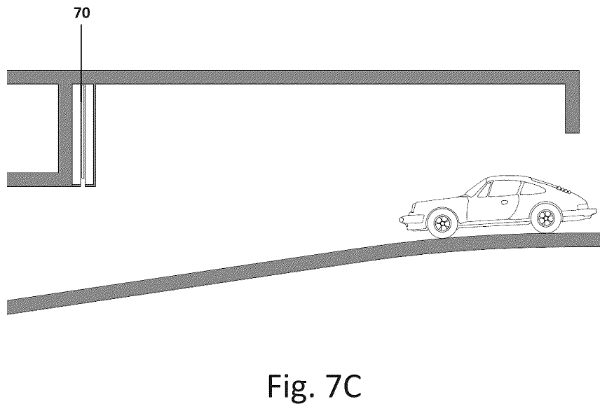

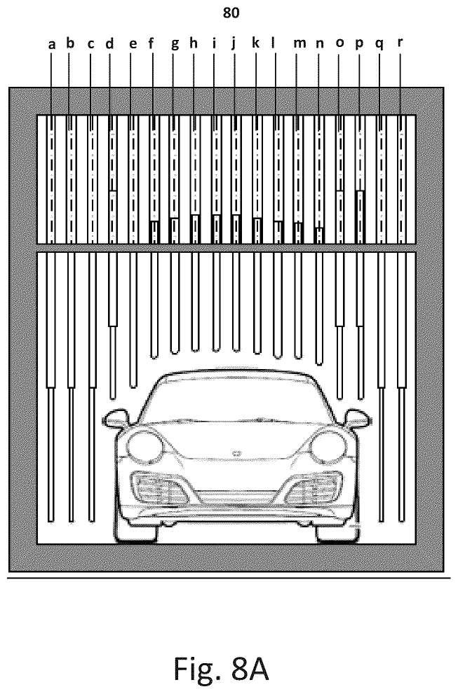

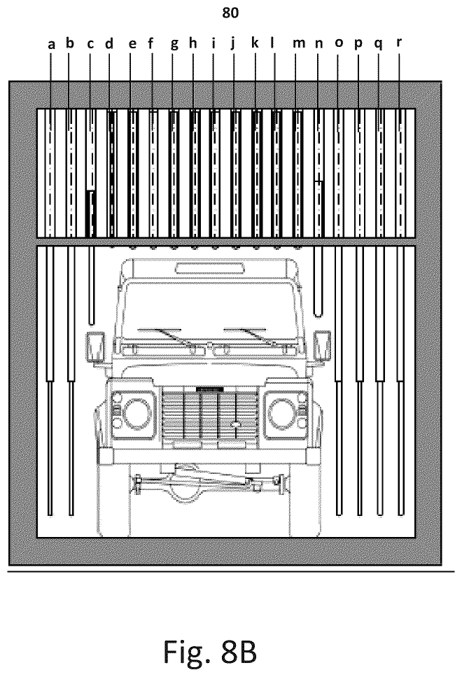

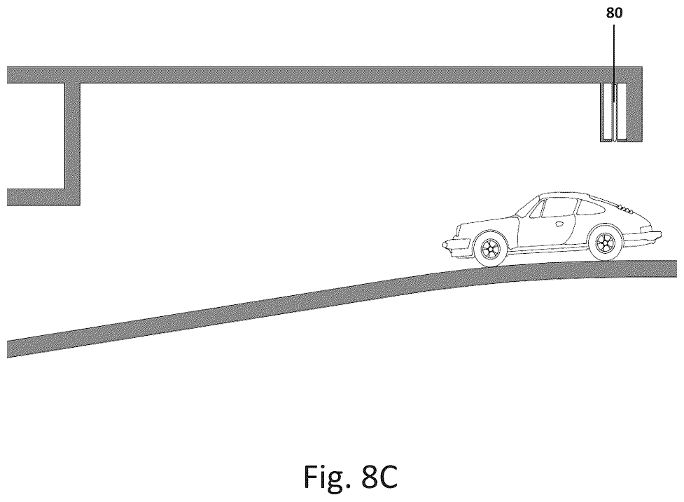

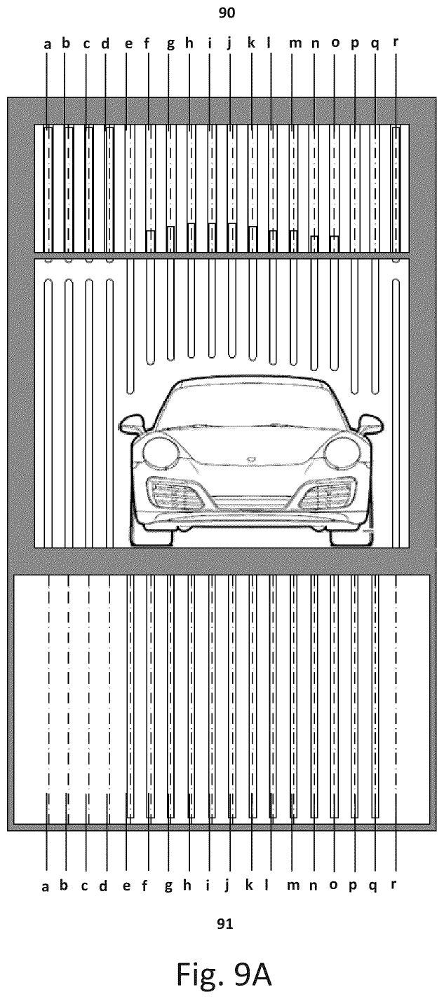

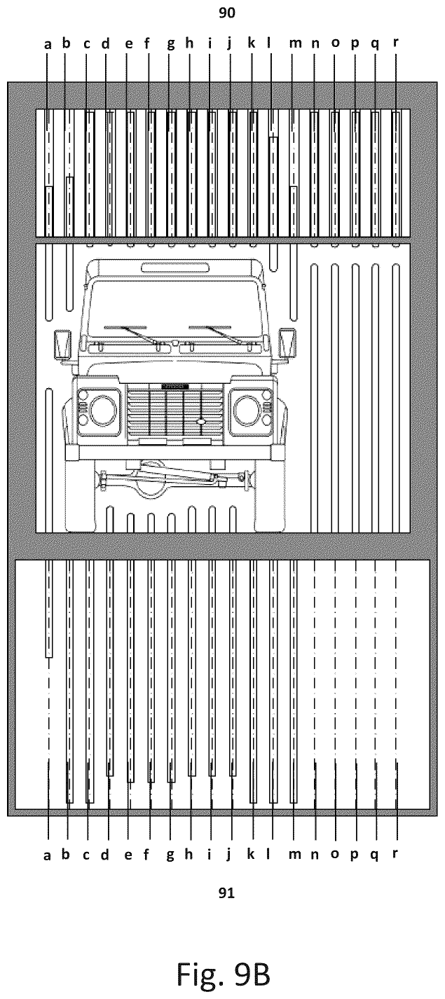

In FIGS. 7A-C and 8A-C a specific embodiment of the present invention as described herein is shown. The gate system in FIGS. 7A-C and 8A-C are based on vertically movable means only. Moveable means are shown herein as an example as bars. In FIGS. 7A-C the gate system is provided with ample space in the ceiling area. In such an area movable means 70a-r can have a length which correspond to the height of passage area. Such passage area might be located deeper in a building as shown in FIG. 7C to provide the necessary ample space in the ceiling area. An alternative embodiment is shown in FIGS. 8A-C. Here the movable means 80a-r are implemented as telescope bars which do not require as much space in the ceiling area as usual bars. As can be seen from FIGS. 7A-B and 8A-B the embodiments with only vertically movable means can also be used to provide a passage area which is adaptable in height and breadth. As illustrated in FIG. 8C a gate system which does not require much space in the ceiling area can be implemented in a building directly at the entrance area. In is also conceivable the vertically movable means can be assembled by movable means from the ceiling and movable means integrated into ground. Also, with a combination of ceiling and ground means an adaptable height can be provided. As shown in FIGS. 9A-B an adaptable height can be provided by a combination of bottom and ceiling means 90a-r and 91a-r. In FIG. 9A the bottom means beneath the passing object are moved into the ground while those elements are sunk close to the top of the object providing only space for the passing object and hinderance for everything else. In case a high object is to pass through the passing area the ceiling means are only slightly, if at all, sunk close to the top of the passing object as shown in FIG. 9B.

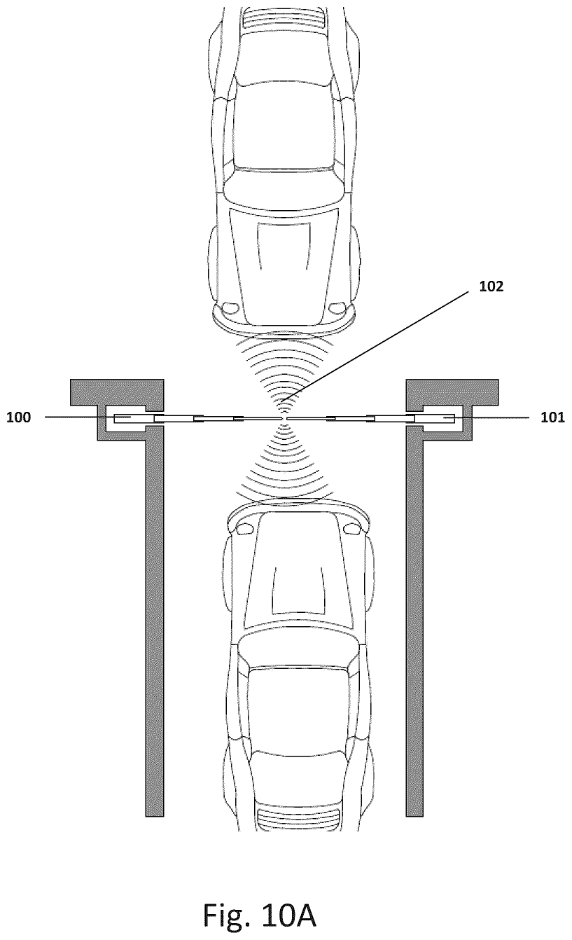

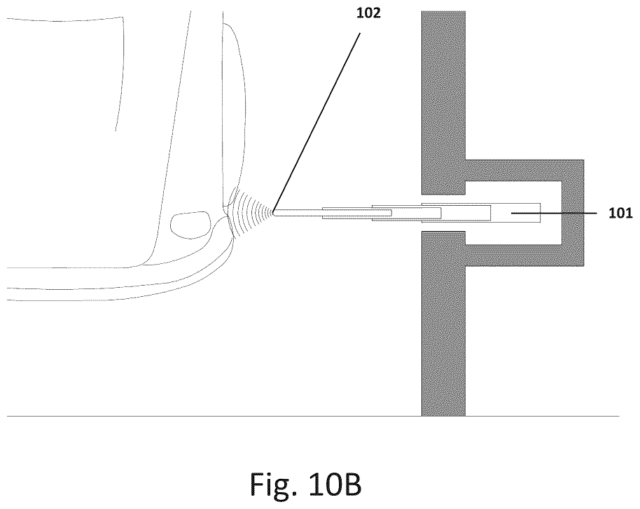

In FIG. 10A distancing is shown which can work in both directions, hence for an object intending to enter, e.g., a building or to leave the same. The object is sensed by sensors 102 located at the tip of the movable means 100 and 101 in a certain distance to the passing area and the shape of the object is determined and recorded. When the object subsequently is approaching the passing area and authorization is given to the object, the movable means 100 and 101 will adopt to a position generating an opening capable of allowing passage of the object while preventing trespassing. FIG. 10B provides an insight into how the distance sensing from the movable means work. From the tip of the movable means, here a telescope bar, the distance is measured from the passing object. The distance between the tip of the movable means and the passing object will be adapted to be constant depending on the shape of the object.

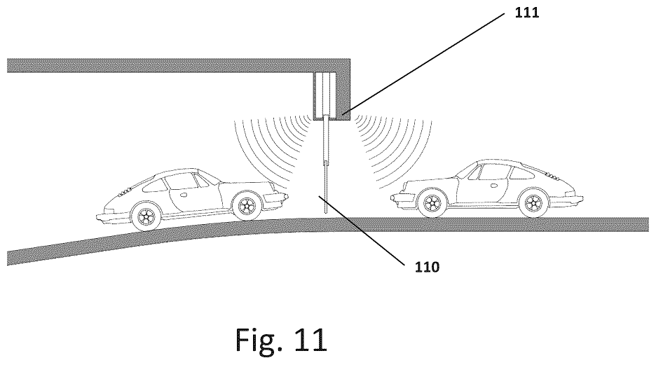

In FIG. 11 an alternative sensing is shown wherein the sensing means 111 are positioned at a top position in front of and behind the passage area. Once the shape of the object is captured and authorization provided, the gate system will provide an opening adapted to the shape of the object by moving the movable means 110 accordingly.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

1. Gate system for entering and exiting a building or installment through a passage area comprising a plurality of moveable means at the passage area in a first position which does not allow passage, characterized in that the means are capable adopting a second position to open the gate by adapting the second position to a distance corresponding to the shape of the passing object to a predetermined value without touching the object.

2. Gate system according to claim 1, wherein the system is configured to shape the opening in breadth and height corresponding to the passing object.

3. Gate system according to claim 1, wherein the means are located at each side of the passage area or at the ceiling of the passage area.

4. Gate system according to claim 1, wherein each movable means has at least one distance sensor at the tip area for measuring the distance to a passing object.

5. Gate system according to claim 4, wherein the distance sensor is located at the tip of the movable means measuring the distance in the extended direction of the bar.

6. Gate system according to claim 4, wherein a distance sensor is located at the tip area directing towards the passing object deviating from in the extended direction of the movable means.

7. Gate system according to claim 1, wherein the movable means are telescope bars or plates with or without sub-plates.

8. Gate system according to claim 1, wherein the movable means are integrated into the side walls and the ceiling.

9. Gate system according to claim 8, wherein the movable means located at the side walls and the ceiling are distanced from each other in direction of passing.

10. Gate system according to claim 1, wherein the movable means are provided from the ceiling and from the bottom.

11. Gate system according to claim 1, wherein the system further comprises distance sensors before and behind the means to per-assess the dimensions of the object to pass to trigger the movement of the means to the second position.

12. Gate system according to claim 1, wherein the system further comprises sending and receiving unit for remotely activating the gate system.

13. Gate system according to claim 12, wherein the sending unit is a remote control.

14. Gate system according to claim 1, wherein the system further comprises a memory function capable of remembering previously passed object shapes and adapting the second position of the bars according to the shape of the previously passed object.

15. Gate system according to claim 1, wherein the system is movable and configured to move from a starting position in front of the passing object to an end position behind the passed object.
